(19) United States
(12) Patent Application Publication
(10) Pub. No.: US 2010/0101673 A1
(43) Pub. Date: Apr. 29, 2010

(54) AERATOR FITTING HAVING CURVED BAFFLE

(76) Inventor: Walter Cornwall, Sea Ranch Lakes, FL (US)

Correspondence Address: YOUNG BASILE, 3001 WEST BIG BEAVER ROAD, SUITE 624, TROY, MI, 48084, US

(21) Appl. No.: 12/258,020

(22) Filed: Oct. 24, 2008

(51) Int. Cl. B01F 5/00

(52) U.S. Cl. 137/896

(57) ABSTRACT

An aerator fitting for coupling waste source piping to a single stack drainage system includes a stack inlet and a stack outlet spaced along a central axis from the stack inlet. An offset chamber fluidly coupling the stack inlet and the stack outlet is offset from the central axis in a direction along an offset axis perpendicular to the central axis. A waste inlet in fluid communication with the stack outlet opens in a direction angled relative to the offset axis. A baffle defines a surface inline with the stack outlet angled toward the waste inlet.

### FIELD OF THE INVENTION

This invention relates to a fitting for a plumbing drainage system, such as an aerator fitting for a single stack drainage system.

### BACKGROUND

In single stack drainage systems, soiled water and waste pass through a single stack pipe without separate ventilation piping. An upstream end of the stack pipe is often vented for controlling pressure in the single stack to reduce back siphoning and gas discharging.

Lateral drainage lines at each floor of a building are generally used to transfer soiled water and waste from sources such as sinks, toilets, and baths into the single stack pipe. The single stack pipe typically includes a fitting at a junction of the lateral drainage line and the single stack pipe.

A downstream end of the single stack pipe can be coupled to a sewage system pipe, which is generally sloped slightly oblique to the horizontal to aid the passage of soiled water and waste. A manhole inspection chamber often provides access to an outlet end of the single stack pipe for rodding the pipe to dislodge any blockages.

### SUMMARY

An example of a fitting for coupling waste source piping to a single stack drainage system according to the invention includes a stack inlet and a stack outlet. The stack outlet is in fluid communication with the stack inlet. A waste source inlet between the stack inlet and the stack outlet is in fluid communication with the stack outlet. A baffle includes a surface inline with the stack outlet. The surface of the baffle is angled toward the waste source inlet.

In another example, an aerator fitting for coupling waste source piping to a single stack drainage system includes a stack inlet and a stack outlet spaced along a vertical axis from the stack inlet. A chamber fluidly couples the stack inlet and the stack outlet, and the chamber is offset from the vertical axis. A waste source inlet is between the stack inlet and the stack outlet, and the waste source inlet is in fluid communication with the stack outlet and laterally spaced from the chamber. A baffle includes a surface inline with the stack outlet angled toward the waste source inlet.

In yet another example, a single stack drainage system for transferring waste from a waste source on a floor of a multi-floor building to a sewage line is described. The drainage system includes a vent at an upstream end of the drainage system. Drainage piping extends substantially vertically downstream from the vent. At least one fitting is included, and the fitting has a stack inlet in fluid communication with an upstream section of the drainage piping, a stack outlet in fluid communication with a downstream section of the drainage piping, and a chamber fluidly coupling the stack inlet and the stack outlet. The chamber is offset from a vertical axis passing through the stack inlet and stack outlet. The fitting also includes a waste source inlet between the stack inlet and the stack outlet fluidly coupling the waste source and the stack outlet, with the waste source inlet laterally spaced from the chamber. The fitting additionally features a baffle including a surface inline with the stack outlet and angled toward the waste source inlet. A downstream end of the drainage system includes a deaerator fitting in fluid communication with the drainage piping and having a waste outlet port coupled to the sewage line and a gas relief line.

### BRIEF DESCRIPTION OF THE DRAWINGS

The description herein makes reference to the accompanying drawings wherein like reference numerals refer to like parts throughout the several views, and wherein:

FIG. 1 is a schematic side view of an example of a drainage system;

FIG. 2 is a perspective view of an example of a fitting;

FIG. 3 is a perspective view of the fitting of FIG. 2 including a cutaway;

FIG. 4 is a cross-section view of the fitting of FIG. 2 along line A-A; and

FIG. 5 is a cross-section view of the fitting of FIG. 2 along line B-B.

### DETAILED DESCRIPTION

Examples of a joint for use in a single stack drainage system are described with reference to FIGS. 1-5. An example of a single stack drainage system 10 is shown in a building 12 having multiple floors 14. The drainage system 10 can include a vent 16 at its upstream end. The vent 16 can allow air to enter into the drainage system 10 to reduce a low pressure zone having a tendency to form behind soiled water and waste traveling downstream in the drainage system 10, thereby reducing back siphoning from other potential sources of gas. Alternatively, a different vent configuration from as shown can be used. For example, the drainage system 10 can include multiple vertically spaced vents.

Vertical piping sections 18 can extend downward from the vent 16. While described as “vertical,” the piping 18 can be obliquely angled relative to the vertical. The piping 18 can transport soiled water and waste downstream from respective floors 14 of the building 12.

More specifically, near each floor 14 requiring drainage, the drainage system 10 can include a fitting 20. Each floor 14 can also include various sources 22 of soiled water and/or waste, such as toilets, showers or baths, and sinks. Each source 22 can be coupled to the fitting 20 via a lateral pipe 24. Each lateral pipe 24 can extend horizontally or at an oblique angle relative to the horizon. Multiple lateral pipes 24 can be used at each floor to couple multiple sources 22 to the vertical piping 18, though more than one source 22 can be in communication with the vertical piping 18 via a single lateral pipe 24.

The drainage system 10 can also include a deaerator fitting 26 at its downstream end or at other locations along the piping 18. The deaerator fitting 26 can include an outlet pipe 28 and a pressure relief line 30. The outlet pipe 28 can be coupled to a sewage pipe 32, which can be horizontal or angled slightly downward as the pipe 32 extends away from the deaerator fitting 26 to aid the flow of soiled water and waste away from the deaerator fitting 26. The pressure relief line 30 can provide an outlet for high pressure gas downstream of descending soiled water and waste, which can reduce gas discharges at other potential gas outlets, such as the lateral pipes 24. Alternatively, depending on its configuration, the drainage system 10 can include a fitting other than the deaerator fitting 26 at its downstream end.

An inspection chamber 34, such as a chamber accessible via a manhole, can allow access to the sewage pipe 32 for cleaning, inspection, and other maintenance purpose. For example, a flexible cleaning rod can be inserted into the sewage pipe 32 for access to the drainage system 10. Additionally, the drainage system 10 can be accessible for cleaning and other operations at alternative or additional locations, such as near each floor 14.

The diameters of the vertical piping 18 and the lateral pipes 24, the locations of the fittings 20, and other aspects of the drainage system 10 can be as described in Design Manual No. 101/o by Sovent, which is hereby incorporated by reference in its entirety. Further, the system 10 can have a different configuration as shown in FIG. 1. For example, as mentioned above, the system 10 can include multiple deaerators 26. As another example, each floor 14 need not include a fitting 20.

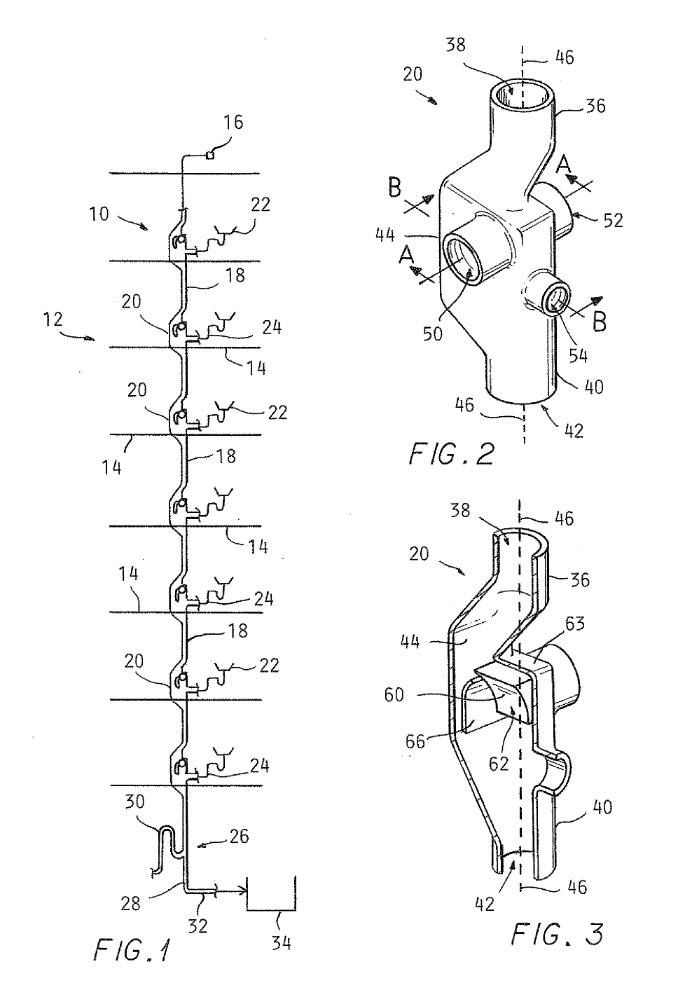

The fitting 20 as shown in FIGS. 2-5 includes an upstream pipe section 36 defining a stack inlet port 38, a downstream pipe section 40 defining a stack outlet port 42, and an offset chamber 44 between the upstream pipe section 36 and the downstream pipe section 40. The upstream pipe section 36 can define a central axis 46 passing longitudinally through a center of the stack inlet port 38. As shown, the central axis 46 can be vertical when the fitting 20 is installed in the drainage system 10, and the axis 46 can extend through a center of the stack outlet port 42 such that the upstream pipe section 36 and downstream pipe section 40 are co-axial. However, the stack outlet port 42 can be spaced downstream of the stack inlet port 38 along the axis 46 even if the two ports 38 and 42 are not coaxial. Also, the upstream pipe section 36, downstream pipe section 40, and offset chamber 44 can have the same diameter.

The offset chamber 44 can be offset laterally from the central axis 46. That is, an axis 48 as shown in FIG. 5 passing longitudinally through a center of the offset chamber 44 parallel to the axis 46 can be spaced from the central axis 46 by a distance 47 along an offset axis 45 perpendicular to the central axis 46. The offset distance 47 can be equal to or greater than a diameter 45 of the upstream and downstream pipe sections 36 and 40 such that a path of soiled water and waste passing from the upstream pipe section 36 to the offset chamber 44 and then to the downstream pipe section 40 cannot be a straight line. That is, the offset distance 47 can force soiled water and waste to move laterally relative to the axis 46 when passing through the fitting 20. Since soiled water and waste can be prevented by the offset chamber 44 from taking a straight line path through the fitting 20, the fitting 20 can slow the speed of descending soiled water and waste, thereby preventing soiled water and waste from reaching terminal velocity or otherwise developing too large of a pressure different between upstream and downstream sides of the soiled water and waste.

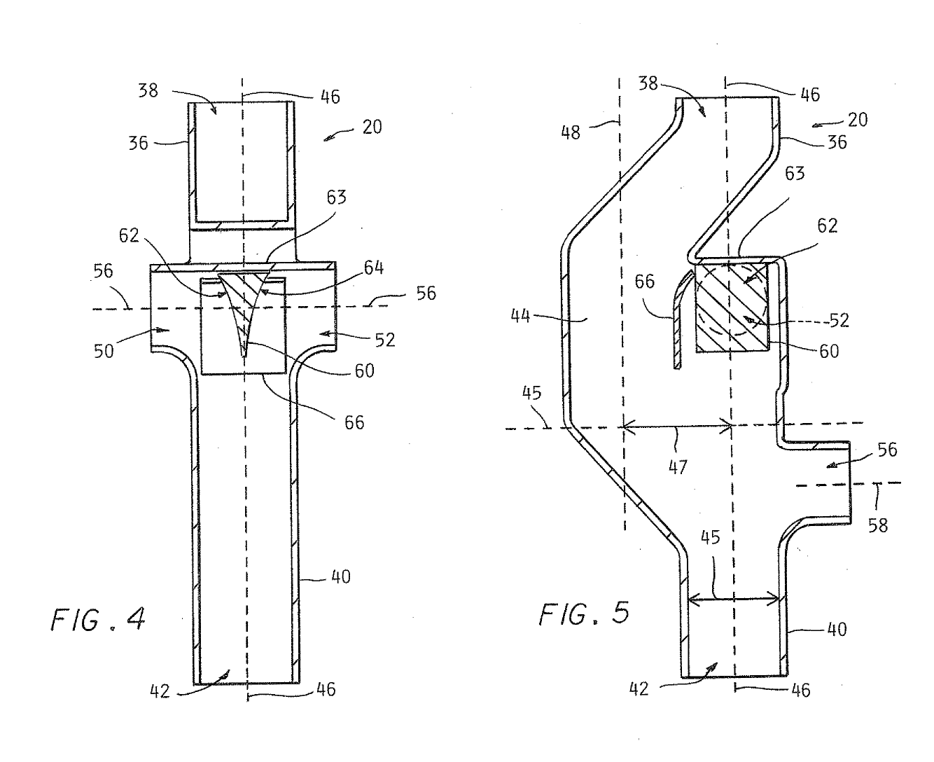

The fitting 20 can also include a first, second, and third waste source inlet ports 50, 52, and 54 as best shown in FIGS. 2. The inlet ports 50, 52, and 54 can be coupled to lateral pipes 24 for receiving soiled water and waste from the sources 22. The first and second inlet ports 50 and 52 can be coaxial, and the ports 50 and 52 can be positioned such that an inlet port axis 56 passing through the centers of the ports 50 and 52 as shown in FIG. 4 intercepts the central axis 46 and is perpendicular to both the central axis 46 and the offset axis 45. As such, the ports 50 and 52 can be laterally offset from the axis 48 of the offset chamber 44. The third waste source inlet port 54 can define an axis 58 shown in FIG. 5 that is perpendicular to the axis 46 as well as to the inlet port axis 56, and the inlet port 54 can be downstream of the first and second inlet ports 50 and 52. Alternatively, the fitting 20 can include a different number of ports, such as only the first and second inlet ports 50 and 52. Also, the positions and orientations of the ports 50, 52, and 54 can vary from as shown in FIGS. 2-5. For example, the fitting 20 can include another port aligned with the third inlet port 54 joining the fitting 20 either above or below the third inlet port 54. As another example, the ports 50, 52, and 54 can be angled such that their axes 56 and 58 are obliquely angled relative to the axis 46.

The diameters of the upstream pipe section 36, downstream pipe section 40, offset chamber 44, and waste source inlet ports 50, 52, and 54 and other aspects of the fitting 20 can be as detailed in Design Manual No. 101/o, which is incorporated by reference in its entirety above.

As shown in FIGS. 3-5, the fitting 20 can include a baffle 60. The baffle 60 can be positioned inline with the stack outlet port 42, meaning an imaginary line parallel to an axis of the outlet port 42 (i.e., the central axis 46 as shown in FIGS. 3-5) can pass through the baffle 60. As a result, a brush or other cleaning tool inserted through the outlet port 42 and moved upstream through the downstream pipe section 40 can contact the baffle 60. Also, while the baffle 60 is shown as centered along the axis 46 in FIG. 4, the baffle 60 can alternatively be located to one side or the other of the axis 46. Further, the baffle 60 need not be symmetric relative to the axis 46 as shown in FIG. 4.

As shown in FIG. 4, the baffle 60 can also be inline with the first and second inlet ports 50 and 52 (i.e., an imaginary line parallel to the axis 56 of the ports 50 and 52 can pass through the baffle 60). For example, the baffle 60 can depend from a portion 63 of the fitting 20 extending between inlet ports 50 and 52. Alternatively, the baffle 60 can be positioned at a different location, such as slightly downstream of the ports 50 and 52, in which case the baffle 60 can extend from a sidewall of the fitting 20 or otherwise be fixed in place. Also, while the baffle 60 is shown in FIG. 5 as extending parallel to the axis 58 by a distance substantially equal to a diameter of the ports 50 and 52 as shown in FIG. 5, the baffle 60 can extend parallel to the axis 58 by a different amount (e.g., the baffle 60 can be shorter than a diameter of the ports 50 and 52).

Additionally, the baffle 60 defines a first surface 62 and a second surface 64 as best shown in FIG. 4. The first surface 62 can curve toward the first waste source inlet port 50 when moving upstream along the central axis 46, and the second surface 64 can curve toward the second waste source inlet port 52 when moving upstream along the axis 46. The surfaces 62 and 64 curve about axes perpendicular to both axes 46 and 56 (i.e., about axes parallel to the axis 58). As such, the first surface 62 can angle toward the first inlet port 50 and the second surface 64 can angle toward the second inlet port 52. Alternatively, the surfaces 62 and 64 can be angled toward the ports 50 and 52, respectively, without being curved. For example, baffle 60 can be V-shaped with the tip of the V pointing downstream, in which case the surfaces 62 and 64 can be planar. Also, the shape of the baffle 60 can depend on the configuration of the fitting 20. For example, if the fitting includes only one of the ports 50 and 52, the baffle 60 can include only one of the angled surfaces 62 and 64.

The baffle 60 can prevent soiled water and waste entering the fitting 20 from one of the waste source inlet ports 50 or 52 from interfering with water and waste entering the fitting from the other of the waste source inlet ports 50 or 52, as the baffle 60 blocks a path from one of the ports 50 or 52 to the other port 50 or 52. In addition to aiding the flow of soiled water and waste within the fitting 20, the baffle 60 can aid in cleaning the waste source inlet ports 50 and 52 and the lateral pipes 24 coupled thereto. A brush or other cleaning tool inserted upstream through the stack outlet port 42 can contact the baffle 60, and a handler of the brush can guide the brush to contact one of the surfaces 62 and 64. The angle of the surface 62 or 64 relative to the path of the brush (i.e., upward along the central axis 46 in the fitting shown in FIGS. 2-5) allows the surface 62 or 64 to direct the brush into one of the ports 50 and 52 for access to the lateral pipes 24. Without the baffle 60 having surface 62 and 64 angled toward the ports 50 and 52, there is no structure to alter the path of the brush into one of the ports 50 and 52. Thus, the baffle 60 can improve flow within the fitting 20 and simplify cleaning the fitting 20 and pipes 24 connected thereto.

The fitting 20 additionally includes a separator 66 between the chamber 66 and the first and second inlet ports 50 and 52. The separator 66 can extend from the portion 63 of the fitting 20, or the separator 66 can depend from the baffle 60 or otherwise be fixed in place. The separator 66 can prevent soiled water and waste that is traveling downstream from the upstream pipe section 36 to the downstream pipe section 40 from interfering with the passages of soiled water and waste into the fitting from the first and second inlet ports 50 and 52.

While the invention has been described in connection with what is presently considered to be the most practical embodiment, it is to be understood that the invention is not to be limited to the disclosed embodiment but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An aerator fitting for coupling waste source piping to a single stack drainage system comprising:
a stack inlet;
a stack outlet spaced along a central axis from the stack inlet;
an offset chamber fluidly coupling the stack inlet and the stack outlet, the offset chamber offset from the central axis in a direction along an offset axis perpendicular to the central axis;
a waste inlet in fluid communication with the stack outlet opening in a direction angled relative to the offset axis; and
a baffle defining a surface inline with the stack outlet angled toward the waste inlet.

2. The aerator fitting of claim 1, wherein the surface of the baffle is inline with the waste inlet.

3. The aerator fitting of claim 1, further comprising a second waste inlet, and wherein the baffle includes a second surface inline with the stack outlet angled toward the second waste inlet.

4. The aerator fitting of claim 3, wherein the waste inlets are coaxial.

5. The aerator fitting of claim 1, wherein the waste inlet opens at a right angle to the offset axis.

6. The aerator fitting of claim 1, wherein the baffle at least partially defines a brush path from the stack outlet to the waste inlet.

7. The aerator fitting of claim 1, wherein the surface of the baffle curves toward the waste inlet from the stack outlet.

8. The aerator fitting of claim 1, further comprising a separator blocking a path of flow from the offset chamber to the waste inlet, and wherein the baffle is on an opposing side of the separator from the offset chamber.

9. The aerator fitting of claim 1, wherein the central axis is perpendicular to an axis of the waste inlet, and wherein the surface of the baffle is oblique to axis of the stack outlet and the axis of the waste inlet.

10. The aerator fitting of claim 1, wherein the stack inlet is configured for fluid communication with an upper portion of the drainage system, wherein the stack outlet is configured for fluid communication with a lower portion of the drainage system, and wherein the waste inlet is configured for fluid communication with the waste source piping.

11. An aerator fitting for coupling waste source piping to a single stack drainage system comprising:
a stack inlet;
a stack outlet spaced along a central axis from the stack inlet;
an offset chamber offset from the central axis, the offset chamber fluidly coupling the stack inlet and the stack outlet;
a first waste inlet in fluid communication with the stack outlet;
a second waste inlet in fluid communication with the stack outlet; and
a baffle inline with the stack outlet defining a first surface angled toward the first waste inlet and a second surface angled toward the second waste inlet.

12. The aerator fitting of claim 11, wherein the first waste inlet and second waste inlet are coaxial.

13. The aerator fitting of claim 11, wherein the baffle is inline with the first inlet and the second waste inlet.

14. The aerator fitting of claim 11, wherein the baffle at least partially defines a first brush path from the stack outlet to the first waste inlet and a second brush path from the stack outlet to the second waste inlet.

15. The aerator fitting of claim 11, wherein the first surface of the baffle curves toward the first waste inlet and the second surface of the baffle curves toward the second waste inlet.

16. The aerator fitting of claim 11, further comprising a separator blocking a path of flow from the offset chamber to the first and second waste inlets, and wherein the baffle is on an opposing side of the separator from the offset chamber.

17. The aerator fitting of claim 11, wherein the stack inlet is configured for fluid communication with an upper portion of the drainage system, wherein the stack outlet is configured for fluid communication with a lower portion of the drainage system, and wherein the first and second waste inlets are configured for fluid communication with the waste source piping.

18. A single stack drainage system for transferring waste from a waste source on a floor of a multi-floor building to a sewage line, the drainage system comprising:
a vent at an upstream end of the drainage system;
drainage piping extending substantially vertically downstream from the vent;
at least one fitting comprising:
a stack inlet in fluid communication with an upstream section of the drainage piping;
a stack outlet spaced along a central axis from the stack inlet, the stack outlet in fluid communication with a downstream section of the drainage piping;
an offset chamber fluidly coupling the stack inlet and the stack outlet, the offset chamber offset from the central axis in a direction along an offset axis perpendicular to the central axis;
a waste inlet in fluid communication with the stack outlet opening in a direction angled relative to the offset axis; and
a baffle defining a surface inline with the stack outlet angled toward the waste inlet; and
a deaerator fitting at a downstream end of the drainage system in fluid communication with the drainage piping and having a waste outlet port coupled to the sewage line and a gas relief line.
